(19) United States
(12) Patent Application Publication
(10) Pub. No.: US 2023/0131948 A1
(43) Pub. Date: Apr. 27, 2023

(54) GLASS SHEET

(71) Applicant: Nippon Electric Glass Co., Ltd., Shiga (JP)

(72) Inventors: Satoko KONOSHITA, Shiga (JP); Takashi MURATA, Shiga (JP)

(21) Appl. No.: 17/911,735

(22) PCT Filed: May 25, 2021
(86) PCT No.: PCT/JP2021/019854

§ 371 Date: Sep. 15, 2022

(30) Foreign Application Priority Data
Jun. 4, 2020 (JP) 2020-097694

(51) Int. Cl. F21V 8/00; G02B 27/01

(52) U.S. Cl. CPC G02B 6/0016; G02B 6/0065; G02B 27/0172

(57) ABSTRACT

Provided is a glass sheet capable of suppressing the generation of stray light when used as a light-guiding plate of an eyeglass-type device such as a head-mounted display. The glass sheet is a glass sheet (1) including a first principal surface (1a) and a second principal surface (1b) opposed to each other and an end surface (1c) connecting the first principal surface (1a) and the second principal surface (1b) to each other, wherein the glass sheet (1) has a refractive index (nd) of from 1.6 to 2.2 and has an R shape in at least part of the end surface (1c), and the end surface (1c) has a surface roughness Ra of 100 nm or less.

### TECHNICAL FIELD

The present invention relates to a glass sheet to be used as a light-guiding plate of a wearable image display device or the like.

### BACKGROUND ART

In recent years, an eyeglass-type device such as a head-mounted display has been developed. A light-guiding plate having transparency may be used in the eyeglass-type device. For example, a see-through type device that enables a user to see an image displayed on the light-guiding plate while looking at outside scenery is also under development. In addition, 3D display can be achieved by displaying different images on the light-guiding plates corresponding to the right and left pupils of the user, or an image can be directly projected onto the retina of the user by coupling the image to the retina through use of the crystalline lens of the pupil.

As a method of displaying an image through use of a light-guiding plate, there is given a method involving causing collimated light or laser light emitted from an image display element to enter the inside of a light-guiding plate through a diffraction grating formed on an incident-side surface on the light-guiding plate, guiding the incident light while allowing the incident light to be totally reflected inside the light-guiding plate, and extracting the light to the outside through a diffraction grating formed on an emission-side surface, to thereby cause the light to enter the pupil of the user. The diffraction grating formed on the surface of the light-guiding plate requires nano-order accuracy, and nanoimprint is often used for forming the diffraction grating. An acrylic resin, which is mainly used as a material for the light-guiding plate, has a large minimum incident angle that causes total reflection, and hence it is difficult for light to propagate while repeating total reflection inside the light-guiding plate. In addition, the resin is inferior in rigidity, and hence it is difficult to apply high-definition nanoimprint. In view of the foregoing, there has been proposed that a glass sheet having a high refractive index and excellent rigidity be used as a light-guiding plate (see, for example, Patent Literature 1).

### CITATION LIST

Patent Literature 1: JP 2017-32673 A

### SUMMARY OF INVENTION

### Technical Problem

Of the light having entered the inside of the light-guiding plate, part of the light having deviated from a proper waveguide path may become stray light. When the stray light is mixed with the emitted light, a digital image may be disturbed.

In view of the foregoing, an object of the present invention is to provide a glass sheet capable of suppressing the generation of stray light when used as a light-guiding plate of an eyeglass-type device such as a head-mounted display.

### Solution to Problem

According to one embodiment of the present invention, there is provided a glass sheet, comprising a first principal surface and a second principal surface opposed to each other and an end surface connecting the first principal surface and the second principal surface to each other, wherein the glass sheet has a refractive index (nd) of from 1.6 to 2.2 and has an R shape in at least part of the end surface, and the end surface has a surface roughness Ra of 100 nm or less. The glass sheet is usually obtained by cutting a glass base material into a predetermined shape and thickness. In this case, as described later, of the light having entered the inside of the glass sheet, the light having reached the end surface of the glass sheet is totally reflected by the end surface of the glass sheet and is liable to become stray light. Meanwhile, when the glass sheet has an R shape in at least part of the end surface, the light having reached the end surface of the glass sheet is easily emitted from the end surface to the outside. In addition, the surface roughness Ra of the end surface is as small as 100 nm or less, and hence the scattering of the light having reached the end surface of the glass sheet on the end surface is suppressed, with the result that the light is easily emitted from the end surface to the outside efficiently.

It is preferred that the glass sheet according to the one embodiment of the present invention have an R shape in an entirety of the end surface. With this configuration, of the light guided inside the glass sheet, the light having reached the end surface of the glass sheet is more easily emitted from the end surface to the outside.

It is preferred that, in the glass sheet according to the one embodiment of the present invention, a difference between a maximum value and a minimum value of a distance between the first principal surface and the second principal surface be 5 μm or less. With this configuration, the light of each wavelength having entered the inside of the glass sheet repeats total reflection between the first and second principal surfaces to be accurately guided, and hence an image to be obtained easily becomes clear.

It is preferred that, in the glass sheet according to the one embodiment of the present invention, the first principal surface and the second principal surface each have a surface roughness Ra of 10 nm or less. With this configuration, when the light having entered the inside of the glass sheet repeats total reflection between the first and second principal surfaces to be guided, scattering loss is less liable to occur, and a bright and clear image is easily obtained.

It is preferred that the glass sheet according to the one embodiment of the present invention have a thickness of 0.5 mm or less. When the thickness of the glass sheet is small in this manner, the weight of the glass sheet becomes small. As a result, the weight of a wearable image display device using the glass sheet as a light-guiding plate becomes small, and the discomfort at the time of wearing of the device can be reduced.

It is preferred that the glass sheet according to the one embodiment of the present invention comprise, as a glass composition, SiO₂, B₂O₃, La₂O₃, and Nb₂O₅.

It is preferred that the glass sheet according to the one embodiment of the present invention have an uneven structure formed on at least one of the first principal surface or the second principal surface. With this configuration, the uneven structure serves as a diffraction grating, and it becomes possible to allow the light emitted from an image display element to enter the inside of the glass sheet and to extract the light guided inside the glass sheet to the outside.

According to another embodiment of the present invention, there is provided a light-guiding plate, comprising the glass sheet according to any one of the above-mentioned embodiments.

It is preferred that the light-guiding plate according to the one embodiment of the present invention be used in a wearable image display device selected from projector-equipped eyeglasses, an eyeglass-type or goggle-type display, a virtual reality (VR) or augmented reality (AR) display device, and a virtual image display device.

According to still another embodiment of the present invention, there is provided a wearable image display device, comprising the light-guiding plate according to any one of the above-mentioned embodiments.

### Advantageous Effects of Invention

According to the present invention, the glass sheet capable of suppressing the generation of stray light when used as a light-guiding plate of an eyeglass-type device such as a head-mounted display can be provided.

### BRIEF DESCRIPTION OF DRAWINGS

FIG. 1 is a schematic side view for illustrating a part of a glass sheet according to one embodiment of the present invention.

FIG. 2 is a schematic side view for illustrating a part of a glass sheet according to another embodiment of the present invention.

FIG. 3 is a schematic side view for illustrating a part of a glass sheet according to Comparative Example.

### DESCRIPTION OF EMBODIMENTS

Embodiments of a glass sheet of the present invention are described below with reference to the drawings. However, the present invention is not limited to the following embodiments.

FIG. 1 is a schematic side view for illustrating a part of a glass sheet according to one embodiment of the present invention. A glass sheet 1 has a first principal surface 1a and a second principal surface 1b opposed to each other, and an end surface 1c connecting the first principal surface 1a and the second principal surface 1b to each other. The planar shape of the glass sheet is not particularly limited, and examples thereof include a polygon such as a rectangle, a circle, and an ellipse.

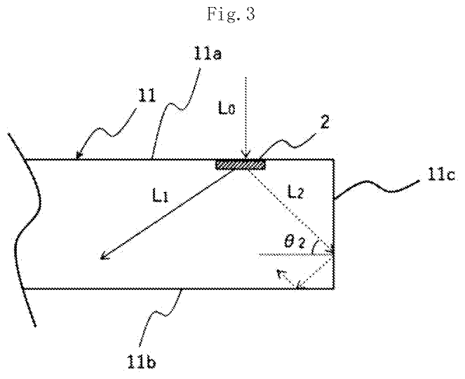

The end surface 1c of the glass sheet 1 has an R shape in at least part thereof. As a result, of the light having entered the inside of the glass sheet 1, the light having reached the end surface of the glass sheet 1 is easily emitted from the end surface 1c to the outside. This point is described below in detail with reference to FIG. 1 and FIG. 3.

As illustrated in FIG. 1, incident light L₀ enters the inside of the glass sheet 1 from the first principal surface 1a of the glass sheet 1a. An uneven structure 2 that functions as a diffraction grating is formed in a region of the first principal surface 1a which the incident light L₀, enters. The incident light L₀ is changed in direction to a width direction of the glass sheet 1a due to the uneven structure 2, and is guided as light L₁ while repeating total reflection between the first principal surface 1a and the second principal surface 1b of the glass sheet 1. Here, part of the incident light L₀ is emitted toward the end surface 1c as light L₂ in a direction different from that of the light L₁. However, the end surface 1c has an R shape, with the result that an incident angle 61 of the light L₂ with respect to the end surface 1c becomes small, and the light L₂ is emitted to the outside without being reflected by the end surface 1c. As an element that functions as a diffraction grating, instead of the uneven structure 2, for example, an engraved line type diffraction grating or a holographic diffraction grating may be used.

Meanwhile, FIG. 3 is a schematic side view for illustrating a part of a glass sheet according to Comparative Example. A glass sheet 11 has a first principal surface 11a and a second principal surface 11b opposed to each other, and an end surface 11c connecting the first principal surface 11a and the second principal surface 11b to each other. In the glass sheet 11, the end surface 11c has a planar shape without having an R shape, which is different from the glass sheet 1. In the glass sheet 11, the end surface 11c has a planar shape without having an R shape, with the result that, as illustrated in FIG. 3, an incident angle θ₂ of light L₂ with respect to the end surface 11c becomes large, and the light L₂ is reflected by the end surface 11c. Even after that, L₂ repeats reflection inside the glass sheet 11 to become stray light.

As described above, in the glass sheet 1 according to the one embodiment of the present invention, stray light is less liable to be generated inside the glass sheet, and when the glass sheet 1 is used as a light-guiding plate of a head-mounted display or the like, the disturbance of a digital image can be suppressed.

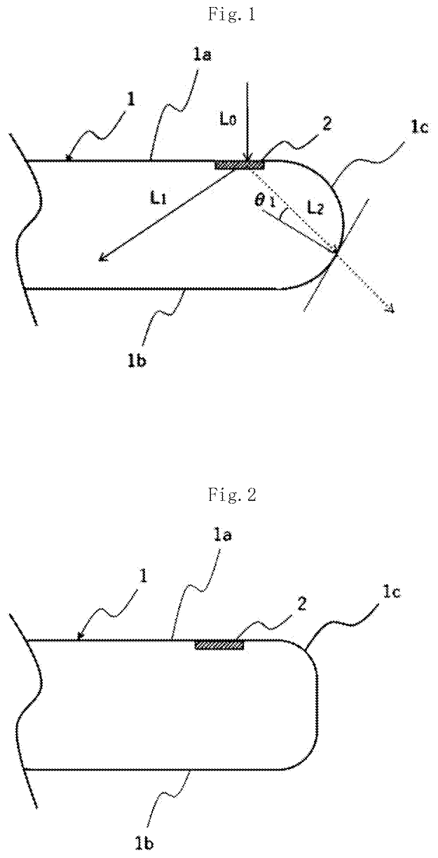

The glass sheet 1 illustrated in FIG. 1 has an R shape in the entirety of the end surface 1c, and the light having reached the end surface 1c can be efficiently emitted to the outside. The glass sheet 1 is not limited thereto, and as illustrated in FIG. 2, may have an R shape in only part of the end surface 1c. With this configuration, the light can be emitted to the outside in at least a portion of the end surface 1c having an R shape.

The surface roughness Ra of the end surface 1c (at least the R-shaped portion) of the glass sheet 1 is preferably 100 nm or less, less than 70 nm, 50 nm or less, 40 nm or less, or 20 nm or less, particularly preferably 10 nm or less. When the surface roughness Ra of the end surface 1c is too large, the light having reached the end surface 1c is scattered on the end surface 1c, and as a result, the light is not easily emitted from the end surface 1c to the outside. The lower limit of the surface roughness Ra of the end surface 1c is not particularly limited, but in actuality, is 1 nm or more. In the present invention, the surface roughness Ra refers to a value measured in accordance with JIS B 0601 (1994).

The refractive index (nd) of the glass sheet 1 is preferably from 1.6 to 2.2, from 1.8 to 2.1, from 1.9 to 2.05, or from 1.95 to 2.03, particularly preferably from 1.98 to 2.01. When the refractive index of the glass sheet 1 is high, the critical angle (critical angle of total reflection) when the light inside the glass sheet 1 is emitted to the outside becomes small, and the light is not easily emitted from the end surface 1c, with the result that stray light is liable to be generated. For this reason, the effect of the present invention can be easily exhibited particularly when the refractive index of the glass sheet 1 is high. When the refractive index is too low, the viewing angle is liable to become narrow when the glass sheet 1 is used as a light-guiding plate of a wearable image display device, such as projector-equipped eyeglasses, an eyeglass-type or goggle-type display, a virtual reality (VR) or augmented reality (AR) display device, or a virtual image display device. Meanwhile, when the refractive index is too high, defects, such as devitrification and striae, are liable to occur.

The Abbe number (vd) of the glass sheet 1 is not particularly limited, but in consideration of the stability of vitrification, the lower limit thereof is preferably 20 or more or 22 or more, particularly preferably 25 or more, and the upper limit thereof is preferably 35 or less or 32 or less, particularly preferably 30 or less.

The difference (TTV=total thickness variation) between a maximum value and a minimum value of the distance between the first principal surface 1a and the second principal surface 1b of the glass sheet 1 is preferably 5 μm or less or 3 μm or less, particularly preferably 1 μm or less. When the TTV is too large, the light of each wavelength having entered the inside of the glass sheet 1 is not easily guided accurately inside the glass sheet 1, and the clearness of an image to be obtained is liable to be decreased.

The surface roughness Ra of each of the first principal surface 1a and the second principal surface 1b of the glass sheet 1 is preferably 10 nm or less, 5 nm or less, or 3 nm or less, particularly preferably 2 nm or less. When the surface roughness Ra of each of the first principal surface 1a and the second principal surface 1b of the glass sheet 1 is too large, scattering loss is liable to occur when the light having entered the inside of the glass sheet 1 repeats total reflection to be guided, and a bright and clear image is not easily obtained. The lower limit of the surface roughness Ra of each of the first principal surface 1a and the second principal surface 1b of the glass sheet 1 is not particularly limited, but in actuality, is 1 nm or more.

The internal transmittance at 450 nm of the glass sheet 1 having a thickness of 10 mm is preferably 90% or more, particularly preferably 92% or more. With this configuration, in the wearable image display device using the glass sheet 1, the brightness of an image seen by the user is easily increased.

The liquidus viscosity of the glass sheet 1 is preferably 10^{0.5} dPa·s or more, 10^{0.6} dPa·s or more, or 10^{0.7} dPa·s or more, particularly preferably 10^{0.8} dPa·s or more. When the liquidus viscosity is too low, it is required to form the glass sheet 1 at low viscosity, and hence defects such as striae are liable to occur in glass particularly when the forming size becomes large. The upper limit of the liquidus viscosity is not particularly limited, but in actuality, is 10^{2.5} dPa·s or less or 10^{1.5} dPa·s or less, particularly 10^{1.2} dPa·s or less.

The thickness of the glass sheet 1 is preferably 0.5 mm or less or 0.4 mm or less, particularly preferably 0.3 mm or less. When the thickness of the glass sheet 1 is too large, the weight of the wearable image display device using the glass sheet 1 becomes large, and the discomfort at the time of wearing of the device is increased. When the thickness of the glass sheet 1 is too small, the mechanical strength is liable to be decreased. Accordingly, the lower limit is preferably 0.01 mm or more, 0.02 mm or more, 0.03 mm or more, or 0.04 mm or more, particularly preferably 0.05 mm or more.

The major axis (diameter in the case of a circle) of the planar shape of the glass sheet 1 is preferably 50 mm or more, 80 mm or more, 100 mm or more, 120 mm or more, 150 mm or more, 160 mm or more, 170 mm or more, 180 mm or more, or 190 mm or more, particularly preferably 200 mm or more. When the major axis of the glass sheet 1 is too small, it becomes difficult to use the glass sheet 1 in applications such as a wearable image display device. Such glass sheet 1 also tends to be inferior in mass productivity. The upper limit of the major axis of the glass sheet 1 is not particularly limited, but in actuality, is 1,000 mm or less.

An example of the glass sheet 1 is a glass sheet comprising, as a glass composition, SiO₂, B₂O₃, La₂O₃, and Nb₂O₅. SiO₂ and B₂O₃ are components that improve vitrification stability and chemical durability. La₂O₃ and Nb₂O₅ are components that significantly increase the refractive index. La₂O₃ also has an improving effect on the vitrification stability. By incorporating those components, it becomes easy to obtain glass having a high refractive index and excellent mass productivity. As a specific composition, there is given a glass sheet comprising, in terms of mass %, 1% to 20% of SiO₂, 1% to 25% of B₂O₃, 10% to 60% of La₂O₃, and 1% to 30% of Nb₂O₅.

In addition to the above-mentioned components, it is preferred that the glass sheet comprise 11 to 30% of TiO₂, which is a component that increases the refractive index, and 0% to 20% of Gd₂O₃. Besides, the glass sheet may comprise Y₂O₃, ZrO₂, and the like. Meanwhile, it is preferred that the glass sheet be substantially free of an As component (e.g., As₂O₃), a Pb component (e.g., PbO), and a fluorine component (e.g., F₂) because of the large environmental load. In addition, it is preferred that the glass sheet be substantially free of Bi₂O₃ and TeO₂ because Bi₂O₃ and TeO₂ are coloring components and the transmittance in a visible region is liable to be decreased. Herein, the phrase “substantially free of” means that a component is not intentionally incorporated as a raw material and the mixing of inevitable impurities is not excluded. Objectively, the phrase means that the content of each of the above-mentioned components is less than 0.1%.

The uneven structure 2 may be formed by, for example, a photolithography method, a sputtering method using a mask, a method involving locally etching through use of a laser after forming a uniform film, or an imprint method using a die.

The glass sheet 1 is suitable as a light-guiding plate that is a constituent member of a wearable image display device selected from projector-equipped eyeglasses, an eyeglass-type or goggle-type display, a virtual reality (VR) or augmented reality (AR) display device, and a virtual image display device. The light-guiding plate is used in a so-called spectacle lens portion of the wearable image display device and plays a role in guiding light emitted from an image display element provided in the wearable image display device and emitting the light toward the pupils of the user.

It is preferred that a plurality of glass sheets 1 be laminated and used as a laminate. With this configuration, when the glass sheet 1 is used as a light-guiding plate of the wearable image display device, images can be projected under a state of being superimposed on one another in a depth direction of a display screen, and a 3D image can be obtained. The number of laminated sheets is preferably 3 or more, particularly preferably 6 or more.

### Examples

Now, the present invention is described in detail by way of Examples, but the present invention is not limited to these Examples.

The composition and characteristics of each of glass sheets manufactured in Examples are shown in Table 1.

TABLE 1

| | | 1 | 2 | 3 | 4 | 5 | 6 |
|---|---|---|---|---|---|---|---|
| Glass | SiO₂ | 32 | 6.6 | 6.4 | 6.6 | 4.7 | 4.1 |
| Composition | B₂O₃ | | 8.8 | 7.3 | 8.6 | 8.3 | 9.6 |
| (mass %) | TiO₂ | 13 | 14.6 | 14.1 | 14.6 | 13.8 | 13.3 |
| | Nb₂O₅ | 36 | 7.4 | 7.2 | 7.4 | 7.1 | 8.3 |
| | ZrO₂ | 6 | 5.9 | 5.7 | 5.9 | 5.6 | 5.4 |
| | La₂O₃ | | 48.2 | 46.7 | 48.2 | 45.7 | 50.2 |
| | Gd₂O₃ | | 7.7 | 7.5 | 7.7 | 9.8 | 7.2 |
| | Y₂O₃ | | 0.8 | 5.1 | 0.7 | 5 | 0.6 |
| | Li₂O | 2 | | | 0.3 | | 1.3 |
| | Na₂O | 11 | | | | | |
| | Sb₂O₃ | 0.05 | | | | | |

| | | | | | | |
|---|---|---|---|---|---|---|
| Refractive index | 1.81 | 2.00 | 2.01 | 1.99 | 2.00 | 2.00 |
| Internal | 93 | 94 | 93 | 96 | 95 | 96 |
| transmittance (%) | | | | | | |
| Liquidus viscosity | 10² | 10¹ | 10^{0.6} | — | — | 10^{0.7} |
| (dPa · s) | | | | | | |
| Surface roughness | 8 | 5 | 5 | 5 | 3 | 3 |
| Ra (nm) of end | | | | | | |
| surface | | | | | | |
| Surface roughness | 1.0 | 0.5 | 0.5 | 0.5 | 0.2 | 0.2 |
| Ra (nm) of principal | | | | | | |
| surface | | | | | | |
| Difference (μm) | 3 | 0.5 | 0.5 | 1 | 0.5 | 0.5 |
| between maximum value | | | | | | |
| and minimum value | | | | | | |
| of distance between | | | | | | |
| first principal | | | | | | |
| surface and second | | | | | | |
| principal surface | | | | | | |
| Sheet thickness (mm) | 0.2 | 0.3 | 0.3 | 0.3 | 0.5 | 0.5 |

The raw materials were blended so as to have each glass composition shown in Table 1 and melted at from 1, 250° C. to 1, 350° C. for from 2 hours to 12 hours through use of a platinum pot. The obtained molten glass was poured into a carbon frame and molded. Then, after the resultant was held at from 720° C. to 780° C. for from 2 hours to 48 hours, the temperature was decreased to room temperature by 1° C./min, to thereby obtain a glass base material.

The refractive index (nd), internal transmittance, and liquidus viscosity of the obtained glass base material were measured. The results are shown in Table 1.

The refractive index was represented by a measured value with respect to a d-line (587.6 nm) of a helium lamp through use of KPR-2000 manufactured by Shimadzu Corporation.

The internal transmittance was measured as described below. Optically polished glass samples having a thickness of 10 mmn±0.1 mm and a thickness of 5 mm±0.1 mm were each measured for a light transmittance (linear transmittance) including a surface reflection loss at intervals of 0.5 nm through use of a spectrophotometer (UV-3100 manufactured by Shimadzu Corporation). Based on the obtained measured values, an internal transmittance τ₁₀ at a thickness of 10 mm was calculated from the following expression. In the table, the values of the internal transmittance at a wavelength of 450 nm are shown.

log τ₁₀=−{(log T₅−log T₁₀)/Δd}×10(%)
T₅: Light transmittance of glass sample having thickness of 5 mm±0.1 mm
T₁₀: Light transmittance of glass sample having thickness of 10 mm±0.1 mm
Δd: Thickness difference between both glass samples

The liquidus viscosity was measured as described below. After the glass base material was remelted in an electric furnace under the conditions of 1,200° C. and 0.5 hour, the glass base material was held in an electric furnace having a temperature gradient for 18 hours. Then, the resultant was taken out from the electric furnace and allowed to cool in the air. The precipitation position of a devitrified product was determined with an optical microscope, to thereby measure a liquidus temperature. Separately, the glass base material was loaded into an alumina crucible and melted by heating. The obtained glass melt was determined for a glass viscosity at a plurality of temperatures by a platinum sphere pull up method. Subsequently, the constant of the Vogel-Fulcher formula was calculated through use of the measured values of the glass viscosity to create a viscosity curve. Through use of the obtained viscosity curve and the liquidus temperature determined above, the viscosity (liquidus viscosity) corresponding to the liquidus temperature was determined.

After the above-mentioned glass base material was cut into a sheet shape having a diameter of 300 mm and a thickness of 0.5 mm, both principal surfaces were sandwiched between a pair of polishing pads having different outer diameters, and both the principal surfaces of the sheet-shaped glass base material were subjected to polishing treatment while the sheet-shaped glass base material and the pair of polishing pads were rotated together. Further, the end surface of the sheet-shaped glass base material was subjected to polishing with a grinder through use of abrasive powder so as to have an R shape. Specifically, the polishing was performed so that the entire end surface was formed into an R shape as illustrated in FIG. 1. In this manner, glass sheets having a thickness of from 0.2 mm to 0.5 mm were obtained.

The difference TTV between a maximum value and a minimum value of the distance between both the principal surfaces of the glass sheet obtained as described above was measured through use of SBW-331ML/d manufactured by Kobelco Research Institute, Inc. In addition, the surface roughness Ra of each of the principal surfaces and the end surface of the glass sheet was measured through use of an atomic force microscope (AFM). The results are shown in Table 1.

Subsequently, a periodic uneven structure made of SiO₂ was formed on one of the principal surfaces of the glass sheet by a photolithography method, and gaps in the uneven structure were filled with a resin. Six of the obtained glass sheets were laminated to obtain a laminate.

When the laminate thus obtained is used as a light-guiding plate of a head-mounted display or the like, the end portion of the light-guiding plate has an R shape, and hence stray light easily comes out from the end portion to the outside. As a result, a 3D image in which the disturbance of a digital image caused by stray light is suppressed can be obtained.

### INDUSTRIAL APPLICABILITY

The glass sheet of the present invention is suitable as a light-guiding plate used in a wearable image display device selected from projector-equipped eyeglasses, an eyeglass-type or goggle-type display, a virtual reality (VR) or augmented reality (AR) display device, and a virtual image display device.

### REFERENCE SIGNS LIST

1, 11 glass sheet
1a, 11a first principal surface
1b, 11b second principal surface
1c, 11c end surface
2 uneven structure

1. A glass sheet, comprising a first principal surface and a second principal surface opposed to each other and an end surface connecting the first principal surface and the second principal surface to each other,
wherein the glass sheet has a refractive index (nd) of from 1.6 to 2.2 and has an R shape in at least part of the end surface, and the end surface has a surface roughness Ra of 100 nm or less.

2. The glass sheet according to claim 1, wherein the glass sheet has an R shape in an entirety of the end surface.

3. The glass sheet according to claim 1, wherein a difference between a maximum value and a minimum value of a distance between the first principal surface and the second principal surface is 5 μm or less.

4. The glass sheet according to claim 1, wherein the first principal surface and the second principal surface each have a surface roughness Ra of 10 nm or less.

5. The glass sheet according to claim 1, wherein the glass sheet has a thickness of 0.5 mm or less.

6. The glass sheet according to claim 1, wherein the glass sheet comprises, as a glass composition, SiO2, B2O3, La2O₃, and Nb2O5.

7. The glass sheet according to claim 1, wherein the glass sheet has an uneven structure formed on at least one of the first principal surface or the second principal surface.

8. A light-guiding plate, comprising the glass sheet of claim 1.

9. The light-guiding plate according to claim 8, wherein the light-guiding plate is used in a wearable image display device selected from projector-equipped eyeglasses, an eyeglass-type or goggle-type display, a virtual reality (VR) or augmented reality (AR) display device, and a virtual image display device.

10. A wearable image display device, comprising the light-guiding plate of claim 8.
